(19) United States
(12) Patent Application Publication
(10) Pub. No.: US 2014/0124309 A1
(43) Pub. Date: May 8, 2014

(54) BRAKE DISK FOR VEHICLE

(71) Applicants: HYUNDAI MOTOR COMPANY, Seoul (KR); KIA MOTORS CORPORATION, Seoul (KR); NAMYANG IND. CO., LTD., Ansan (KR)

(72) Inventors: Yoon Cheol Kim, Suwon (KR); Jae Young Lee, Yongin (KR); Seong Jin Kim, Yongin (KR); Jai Min Han, Ansan (KR); Sung Jong Hong, Seoul (KR); Ki Jeong Kim, Siheung (KR)

(73) Assignees: Hyundai Motor Company, Seoul (KR); Namyang Ind. Co., Ltd., Ansan (GB); Kia Motors Corporation, Seoul (KR)

(21) Appl. No.: 13/717,101

(22) Filed: Dec. 17, 2012

(30) Foreign Application Priority Data
Nov. 6, 2012 (KR) 10-2012-0124753

(51) Int. Cl. F16D 65/12

(52) U.S. Cl. CPC F16D 65/123; F16D 65/125
USPC 188/218 XL

(57) ABSTRACT

Disclosed herein is a brake disk for a vehicle including: a hat including a recessed portions radially extending around an outer circumference surface of the hat; a braking band including a friction face along an outer circumference surface of the braking band and a mounting aperture formed along the inner circumference of the friction face at a position corresponding to the recessed portions; a floating bush including one end mounted on the mounting aperture and the other end fitted in the recessed portions to move in the recessed portions; and a tensioner including a middle portion fixed to the floating bush by a fixing member and both ends supported to one side of the hat under axial tension.

### CROSS-REFERENCE TO RELATED APPLICATION

This application claims under 35 U.S.C. §119(a) the benefit of Korean Patent Application No. 10-2012-0124753, filed Nov. 6, 2012, the entire contents of which are incorporated herein by reference.

### BACKGROUND

(a) Technical Field

The present invention relates to a brake disk for a vehicle, and more particularly, to a brake disk for a vehicle which improves fuel efficiency by reducing the weight of the brake disk without decreasing the performance of the brake disk by improving the structure for fastening a hat and a braking band.

(b) Background Art

In general, vehicle manufacturers are developing technologies for improving fuel efficiency due to the lack of oil energy and the climate change. A technology of reducing the weigh to of a vehicle without decreasing the performance has been developed for improving fuel efficiency. In particular, since reducing vehicle weight in connection with load of driving a wheel is efficient for improving fuel efficiency, related technologies are being researched and developed.

FIG. 1 shows a brake disk of the related art, and as shown in the figure, the brake disk is composed of a hat 1 to be mounted on a hub and a circular disk 2 which creates friction during braking. Both the hat 1 and the disk 2 of the brake disk are made of gray cast iron, a material showing excellent brake characteristics, such as, high vibration attenuation performance, damping performance, heat dissipation performance, and lubrication performance due to the flake graphite structure. However, fuel efficiency decreases due to the specific weight of the gray cast iron, which is about 7.2 g/cm³.

The description provided above as a related art of the present invention is just for helping understanding the background of the present invention and should not be construed as being included in the related art known by those skilled in the art.

[NOTE: Please add the above references to the Information Disclosure Statement.]

### SUMMARY OF THE DISCLOSURE

The present invention has been made in an effort to provide a brake disk for a vehicle which reduces the weight of the brake disk and improves fuel efficiency without decreasing the performance of the brake disk by improving the structure for fastening a hat and a braking band.

The present invention, includes: a hat including a plurality of recessed portions radially extending around an outer circumference surface of the hat; a braking band including a friction face along the outer circumference surface of the braking band and a mounting aperture formed along the inner circumference of the friction face at a position corresponding to the recessed portions; a floating bush including one end mounted on the mounting aperture and the other end fitted in the recessed portions to be radially movable in the recessed portions; and a tensioner including a middle portion fixed to the floating bush by a fixing member and both ends supported to one side of the hat under axial tension to absorb axial displacement generated in the braking band. A guide plate is fitted in the recessed portions and the floating bush may be fitted in the guide plate.

The guide plate may have a fitting portion fitted in the recessed portions and a first cover portion and a second cover portion that extend from both ends of the fitting portion and bend at both ends of the fitting portion to cover both sides of the hat and the recessed portions, and both ends of the tensioner may be supported under tension by one bending side of the guide plate. The guide plates may be separately mounted on both inner sides of the recessed portions.

A guide fixing member may bend toward the floating bush, at both sides of the fitting portion, and a tensioner fixing member may bend toward the floating bush at both sides of the middle portion of the tensioner. The hat may be formed of a light thermal conductive material and the guide plate may be formed of iron metal to resist against the pressing of the tensioner. The tensioner may have a supported portion supported by the other end of the floating bush, a plurality of bending portions that bend and extend from both ends of the supported portion under tension, and a tension pressing portion that extends from the bending portion and presses one side of the hat with the end under tension.

A predetermined gap may be maintained to position a first support surface supporting the middle portion of the tensioner and a second support surface supporting both ends of the tensioner on horizontal planes with different heights. The fixing members may be thread fastened through an axial center of the floating bush, to fasten the floating bush and the tensioner by the thread fastening.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is an exemplary view showing a brake disk for a vehicle according to the related art;

FIG. 2 is an exemplary enlarged view prior to assembly of a brake disk for a vehicle according to an exemplary embodiment of the present invention;

FIG. 3 is an exemplary view showing the assembled hat and braking band according to an exemplary embodiment of the present invention;

FIG. 4 is an exemplary cross-sectional view taken along line A-A shown in FIG. 3 according to an exemplary embodiment of the present invention; and

FIG. 5 is an exemplary front view showing the assembled brake disk according to an exemplary embodiment of the present invention.

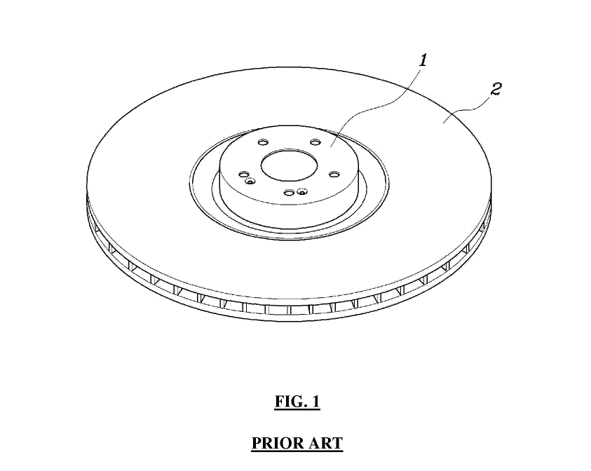

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various embodiments of the present invention, examples of which are illustrated in the accompanying drawings and described below.

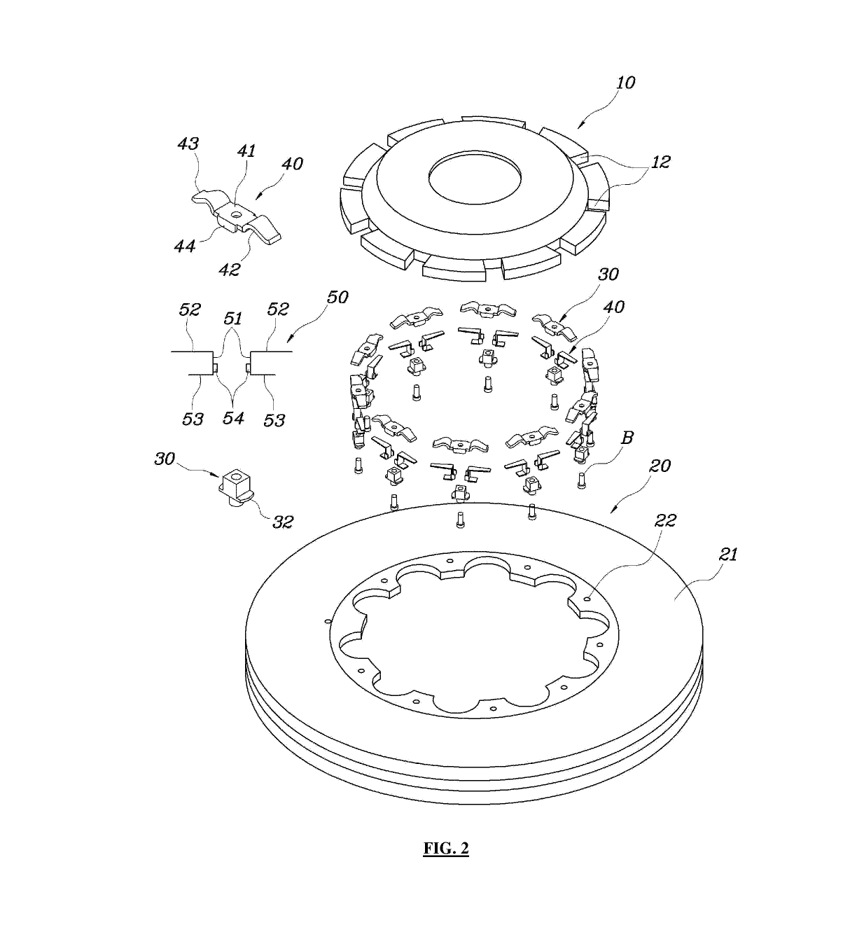

A brake disk for a vehicle of the present invention, which is shown in FIGS. 2 to 5, may include a hat 10, a braking band 20, a floating bush 30, and a tensioner 40.

In particular, the brake disk may include a hat 10 having a plurality of recessed portions 12 repeatedly formed at a predetermined interval along an the outer circumference surface of the hat 10, a braking band 20 having a friction face 21 along the outer circumference surface of the braking band and a mounting aperture 22 formed along the inner circumference of the friction face 21 at a position corresponding to the recessed portions 12, a floating bush 30 having one end mounted on the mounting aperture 22 and the other end fitted in the recessed portions 12 to be radially movable in the recessed portions 12, and a tensioner 40 having a middle portion fixed to the floating bush 30 by a fixing member and both ends of the tensioner may be supported to one side of the hat 10 under axial tension to absorb axial displacement generated in the braking band 20.

FIG. 2 is an exemplary enlarged view prior to assembly of a brake disk for a vehicle according to the present invention and FIG. 3 is an exemplary view showing the assembled hat 10 and braking band 20 according to the present invention. Referring to FIGS. 2 and 3, the hat may be disposed with a center fitted on a rotary shaft 15, on a hub, and a plurality of recessed portions 12 may be formed at predetermined intervals around the outer circumference of the hat.

The recessed portions 12 may be long in the radial direction of the hat 10, so the floating bush 30 may move in the recessed portions 12 in the radial direction of the hat 10. For this configuration, the width of recessed portions 12 may correspond to the outer width of the floating bush 30 and the floating bush 30 may be guided along the recessed portions 12. The outer circumference of the recessed portions 12 may be open such that the floating bush 30 may move.

The braking band 20 may be assembled with the hat 10 and may include the friction face 21 around the outer circumference. of the braking band The braking band 20 may be formed in a circular plate and molded using casting gray iron. Further, the braking band 20 may be a solid composed of one circular plate or a ventilated plate formed by connecting a plurality of ribs between two circular plates, thereby improving the cooling performance.

Further, the plurality of mounting apertures 22 may be formed around the inner circumference of the friction face 21 at positions corresponding to the recessed portions 12, in predetermined intervals around the circumference of the braking band 20.

The floating bush 30 may include one end fitted in the mounting aperture 22 of the braking band 20 and the other end fitted in the recessed portions 12 of the hat 10. Further, a flange 32 may be formed between the ends thereby disposing the hat 10 in contact with one side of the flange 32 and the braking band 20 in contact with the other side of the flange 32. In other words, both ends of the floating bush 30 may be fastened to the mounting aperture 22 and the recessed portions 12, respectively, so the braking band 20 and the hat 10 restrict circumferential relative rotation with each other.

As described above, the flowing bush 30 may be movable in the radial direction of the hat 10, in the recessed portions 12. In other words, since high temperature heat may be generated from the braking band 20 during vehicle braking, when the floating bush 30 is fixed, stress due to thermal expansion of the braking band 20 may concentrate on the floating bush 30, the floating bush 30 is movable in the radial direction of the heat 10 to remove the stress.

A tensioner 40 may be formed in a leaf spring shape, with the middle portion fixed to the floating bush 30, and the floating bush 30 and the tensioner 40 may be fixed to each other by fixing members. Further, both ends of the tensioner 40 may be supported by one side of the hat 10, under tension in the axial direction of the hat 10. Axial displacement may be generated in the braking band 20 by disk run out and disk thickness variation, and the axial displacement may be absorbed and reduced by tension of the tensioner 40.

The fixing members may be thread fastened through the axial center of the floating bush 30, to fasten the floating bush 30 and the tensioner 40 by the thread-fastening. In other words, a threaded bore may be formed at the center of the floating bush 30, a bolt B may be inserted in the threaded bore, and a nut N may be thread fastened to the other end of the bolt B, to fasten the tensioner 40 to the floating bush 30.

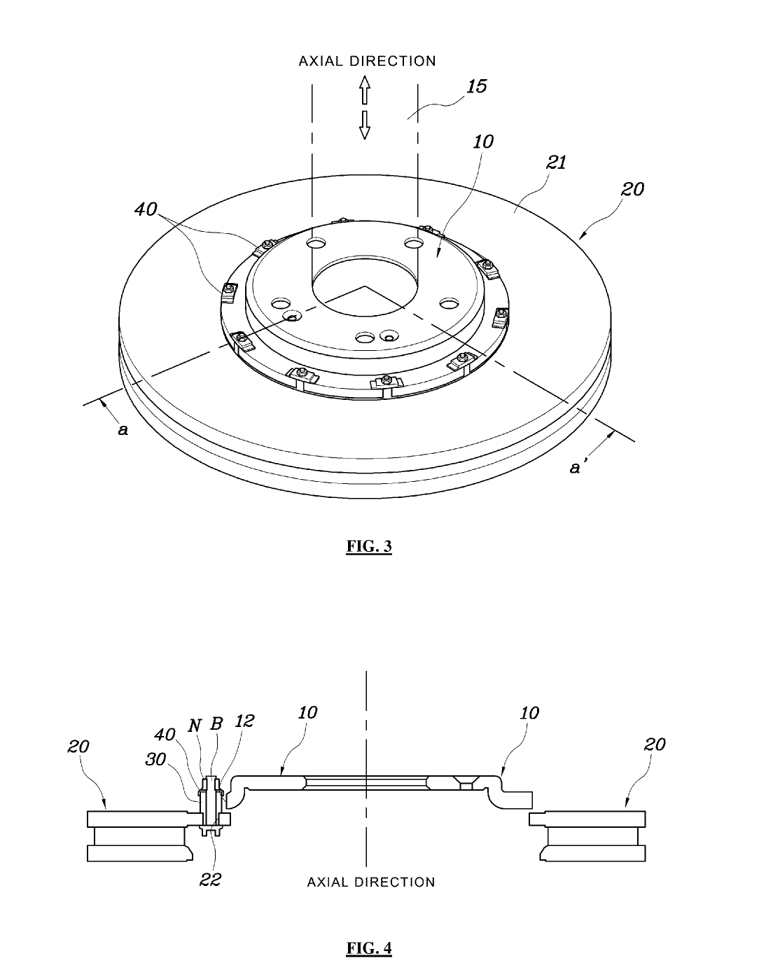

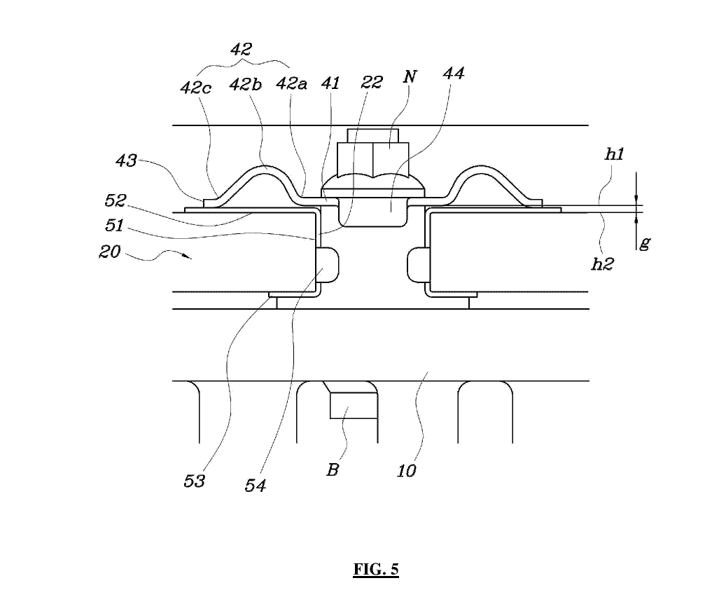

FIG. 4 is an exemplary cross-sectional view taken along line A-A shown in FIG. 3 and FIG. 5 is an exemplary front view showing the assembled brake disk according to the present invention. Referring to FIGS. 4 and 5, a guide plate 50 may be fitted in the recessed portions 12 and the floating bush 30 may be fitted in the guide plate 50. The guide plate 50 may be formed and manufactured by iron metal and the floating bush 30 may be more smoothly moved in the recessed portions 12 by the guide plate 50.

Further, the guide plate 50 may have a fitting portion 51 fitted in the recessed portions 12 and a first cover portion 52 and a second cover portion 53 that extend from both ends of the fitting portion 51 and bend at both ends of the fitting portion 51 to cover both sides of the hat 10 and the recessed portions 12.

In other words, the fitting portion 51 may be fitted in the recessed portions 12, the first cover portion 52 may bend toward one side of the hat 10 in contact with one end of the recessed portions 12 while extending at one end of the fitting portion 51, and the second cover portion 53 may bend to the other side of the hat 10 in contact with the other end of the recessed portions 12 while extending at the other end of the fitting portion 51.

In particular, both ends of the tensioner 40 may be supported under tension by one bending side of the guide plate 50, that is, the outer surface of the first cover 52. Further, the hat 10 may be formed from a light thermal conductive material, such as aluminum. Therefore, the weight of the hat 10 may be reduced and fuel efficiency may be improved.

However, since the hat 10 may be formed of soft aluminum, the hat 10 may be worn by pressing of the tensioner 40, so the guide plate 50 is fitted in the recessed portions 12 so both ends of the tensioner 40 are not pressed directly to the surface of the hat 10, but to the guide plate 50. Therefore, it may be possible to prevent wear to the hat 10 by a pressing force of the tensioner 40, thereby preventing reduction of tension of the tensioner 40.

Referring to FIG. 2, the guide plates 50 may be separately mounted on both inner sides of each recessed portion 12. In other words, two guide plates 50 may be fitted on each recessed portion 12. Thus, when a guide plate 50 is damaged, only the damaged guide plate 50 need be replaced.

Further, referring to FIG. 5, a guide fixing member 54 may bend toward the floating bush 30, at both sides of the fitting portion 51, and a tensioner fixing member 44 may bend toward the floating bush 30 at both sides of the middle portion of the tensioner 40.

In other words, the guide plate 50 may be attached to the floating bush 30 by the guide fixing member 54 formed at the fitting portion 51 and the tensioner 40 may be attached to the floating bush 30 by the tensioner fixing member 44 formed at the tensioner 40, so the tensioner 40 and the guide plate 50 move together in the radial direction of the hat 10 during thermal expansion of the braking band 20.

On the other hand, referring to FIG. 5, the tensioner 40 may have a support portion 41 supported by the other end of the floating bush 30, a plurality of bending portions 42 that bend and extend from both ends of the support portion 41 under tension, and a tension pressing portion 43 that extends from the bending portion 42 and presses one side of the hat with the end under tension. The tensioner 40 may be formed of iron metal with a thickness of about 1˜2 mm.

In other words, the tensioner 40 may be formed in a leaf spring shape, and referring to FIG. 5, the support portion 41 at the middle portion of the tensioner 40 may be fixed and supported on the other end of the floating bush 30, the bending portions 42 extend from both ends of the support portion 41, and the tension pressing portion 43 may be formed at the end of the bending portions 42.

The bending portion 42 may include a first bending portion 42a bending upward from the support portion 41, a second bending portion 42b bending downward in a substantially semicircular shape from the first bending portion 42a, and a third bending portion 42c inclining downward from the second banding portion 42b and then bending toward the horizon of the hat 10. Since the tensioner 40 may be composed of the support portion 41, the bending portion 42, and the tension pressing portion 43 and has elasticity, the tensioner may press the guide plate 50 in the axial direction of the hat 10 and may absorb and reduce an axial displacement generated by the braking band 20.

Further, as shown in FIG. 5, a predetermined gap (g) may be maintained between a first support surface (h1) supporting the middle portion of the tensioner 40 and a second support surface (h2) supporting both ends of the tensioner 40 positioning the first support surface (h1) and the second support surface (h2) on horizontal planes with different heights. The gap (g) may be about 0.2˜0.6 mm. In other words, as the predetermined gap g is maintained between the first support surface h1 and the second support surface (h2), an axial displacement generated by the braking band 20 may be more smoothly absorbed and reduced.

According to the present invention, the hat may be formed of a light material and the hat and braking band may be assembled by the fastening parts such as the floating bush, the tensioner, and the guide plate, and the weight of the brake disk may be reduced and fuel efficiency may be improved.

Further, the tensioner used for assembling the hat and the braking band may provide an elastic force in the axial direction of the rotary shaft and the support surface supporting the center of the tensioner and the support surface supporting both ends of the tensioner may be different in height, so an axial displacement generated by the braking band may be absorbed and reduced.

The invention has been described in detail with reference to exemplary embodiments thereof. However, it will be appreciated by those skilled in the art that changes may be made in these embodiments without departing from the principles and spirit of the invention, the scope of which is defined in the accompanying claims and their equivalents.

What is claimed is:

1. A brake disk for a vehicle comprising:
a hat including a a plurality of recessed portions radially extending around an outer circumference surface of the hat;
a braking band including a friction face along an outer circumference surface of the braking band and a mounting aperture formed along an inner circumference of the friction face at a position corresponding to the recessed portions;
a floating bush including one end mounted on the mounting aperture and an other end fitted in the recessed portions to radially move into the recessed portions; and
a tensioner including a middle portion fixed to the floating bush by a fixing member, wherein both ends of the tensioner are supported to one side of the hat under axial tension.

2. The brake disk of claim 1, further comprising a guide plate fitted in the recessed portions, wherein the floating bush is fitted in the guide plate.

3. The brake disk of claim 2, wherein the guide plate includes:
a fitting portion fitted in the recessed portions;
a first cover portion of the fitting portion; and
a second cover portion, wherein the first and the second cover portions extend from both ends of the fitting portion and bend at both ends of the fitting portion to cover both sides of the hat and the recessed portions.

4. The brake disk of claim 3, wherein both ends of the tensioner are supported under tension by one bending side of the guide plate.

4. The brake disk of claim 3, wherein a plurality of guide plates are separately mounted on both inner sides of the recessed portions 12.

5. The brake disk of claim 3, further comprising:
a guide fixing member bending toward the floating bush, at both sides of the fitting portion; and
a tensioner fixing member bending toward the floating bush at both sides of the middle portion of the tensioner.

6. The brake disk of claim 3, wherein the hat is formed of a light thermal conductive material and the guide plate is formed of iron metal.

7. The brake disk of claim 1, wherein the tensioner further includes:
a supported portion supported by the other end of the floating bush;
a plurality of bending portions that bend and extend from both ends of the supported portion under tension; and
a tension pressing portion that extends from the bending portion and presses one side of the hat with the end under tension.

8. The brake disk of claim 1, wherein a predetermined gap is maintained to position a first support surface supporting the middle portion of the tensioner and a second support surface supporting both ends of the tensioner on horizontal planes with different heights.

9. The brake disk of claim 1, wherein the guide fixing member IS thread fastened through an axial center of the floating bush, to fasten the floating bush and the tensioner by the thread fastening.

10. A hat for a disk brake of a vehicle comprising:
recessed portions radially extending around an outer circumference surface of the hat and configured to come in contact with a friction face of a braking band along an outer circumference surface of the braking band and a mounting aperture formed along an inner circumference of the friction face at a position corresponding to the recessed portions;
wherein a floating bush is mounted on the mounting aperture and an other end fitted in the recessed portions to radially move into the recessed portions, and a tensioner including a middle portion is fixed to the floating bush by a fixing member, wherein both ends of the tensioner are supported to one side of the hat under axial tension.
